(19) United States
(12) Patent Application Publication
(10) Pub. No.: US 2007/0053354 A1
(43) Pub. Date: Mar. 8, 2007

(54) Method and system for securing wireless transmission of an aggregated frame

(75) Inventors: Marian Rudolf, Montreal (CA); Mohammed Sammour, Montreal (CA); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/445,388

(22) Filed: May 31, 2006

Related U.S. Application Data
(60) Provisional application No. 60/709,296, filed on Aug. 18, 2005.

(51) Int. Cl. H04L 12/56; H04J 3/04

(52) U.S. Cl. 370/389; 370/535

(57) ABSTRACT

A method and apparatus for securing the wireless transmission of an aggregated frame are disclosed. An aggregated frame is generated by aggregating at least one subframe and a security field. The security field is used to secure the entire aggregated frame. The contents of the security field may be generated from a group key or a pairwise key. For example, the security field may include an initialization vector (IV), an extended IV (EIV), a message integrity code (MIC) and an integrity check value (ICV). When a group key is used for a group of receivers, the group key may be changed as a new receiver enters into the group or an existing receiver leaves the group. Alternatively, the group key may be changed periodically. The subframes may be data frames, control frames, management frames, action frames or any type of frames.

### CROSS REFERENCE TO RELATED APPLICATION

This application claims the benefit of U.S. Provisional Application No. 60/709,296 filed Aug. 18, 2005, which is incorporated by reference as if fully set forth.

### FIELD OF INVENTION

The present invention is related to wireless communications security. More specifically, the present invention is related to a method and system for securing the wireless transmission of an aggregated frame.

### BACKGROUND

Frame aggregation and frame bursting are two mechanisms that are proposed for enhancing the performance of wireless local area network (WLAN) systems. Such mechanisms are under consideration for the IEEE 802.11n extension to the IEEE 802.11 standards. Both TGnSync and WWiSE proposals are considering various types of frame aggregation and bursting schemes for improving WLAN performance.

FIGS. 1A-1D show various types of conventional frame aggregations and bursting schemes in accordance with the TGnSync and WWiSE proposals. FIG. 1A shows a medium access control (MAC) protocol data unit (MPDU) containing an aggregated MAC service data unit (A-MSDU) which aggregates one or more MAC service data units (MSDUs). FIG. 1B shows a physical layer (PHY) protocol data unit (PPDU) containing an aggregated MAC PDU (A-MPDU) which aggregates one or more MAC protocol data units (MPDUs). FIG. 1C shows an aggregated PPDU (A-PPDU) which aggregates one or more PPDUs. FIG. 1D shows PPDU bursting, (also known as HTP burst transmission), where a sequence of frames is transmitted in a single medium access. The frames may be transmitted as part of an A-PPDU, or with reduced interframe spacing (RIFS) to enhance medium efficiency.

Aggregation or bursting schemes can support aggregating PDUs destined to a single receiver, (i.e., a single receiver aggregation (SRA)), multiple receivers, (i.e., multiple receiver aggregation (MRA)), or both. The MSDU aggregation scheme of FIG. 1A is typically used for SRA since it contains only one MAC header, which can identify an address of a single receiver. On the other hand, the MPDU aggregation, PPDU aggregation and PPDU bursting schemes of FIGS. 1B-1D can be used for the SRA or the MRA, since each MPDU within the aggregate or burst contains a MAC header which can identify multiple WLAN receiver addresses.

In order to enhance security of WLAN systems, the IEEE 802.11i standard has been developed. However, the IEEE 802.11i standard does not provide security solutions for the frame aggregation proposed for IEEE 802.11n. FIG. 2 shows an MPDU 200 including an A-MSDU 202 comprising a plurality of subframes 203a-203n. Each of the subframes 203a-203n includes a subframe header 204. Two types of subframe headers 210, 212 are shown in FIG. 2. The subframe header 212 includes an initialization vector (IV) field 214 and an extended IV (EIV) field 216, while the subframe header 210 does not. For securing a transmission of an A-MSDU 202, it has been proposed to include an IV field and an EIV field within a sub-frame header 204 of each MSDU 206, such as the subframe header 212. However, in accordance with such proposals, while each MSDU 206 carries its own field for encryption and integrity protection, there is no field to provide security and integrity protection on the overall A-MSDU 202.

Similarly, for MPDU aggregation, (or PPDU aggregation), a scheme of including an IV field and an EIV field directly within each MPDU MAC header has been proposed. However, in accordance with such proposal, while each MPDU carries within its MAC header some fields for encryption and integrity protection, there is no field to provide security and integrity protection on the overall A-MPDU. Therefore, an A-MPDU, an A-MSDU or an A-PPDU itself is not protected, even though the individual data payloads, (i.e., MPDUs or MSDUs), are.

In a conventional wireless communication system with the above security measures, no attacker could read or change contents of an individual MPDU or MSDU, since every individual MPDU or MSDU is protected by conventional encryption and/or integrity protection mechanisms by IEEE 802.11i. However, even though the individual MPDU or MSDU can be considered to be secured, their aggregation in the A-MPDU or A-MSDU is not secure because an attacker can selectively cut-and-paste an individual MPDU or MSDU and replace it with contents of a previously recorded MPDU or MSDU without being noticed. This kind of attack is referred to as “replay-attack.” Therefore, it is desirable to provide a solution to secure an entire aggregated frame.

### SUMMARY

The present invention is related to a method and apparatus for securing the wireless transmission of an aggregated frame. An aggregated frame is generated by aggregating at least one subframe and a security field. The security field is used to secure the entire aggregated frame. The contents of the security field may be generated from a group key or a pairwise key. For example, the security field may include an IV, an EIV, a message integrity code (MIC) and an integrity check value (ICV). When a group key is used for a group of receivers, the group key may be changed as a new receiver enters into the group or an existing receiver leaves the group. Alternatively, the group key may be changed periodically. The subframes may be data frames, control frames, management frames, action frames or any type of frames.

### BRIEF DESCRIPTION OF THE DRAWINGS

FIGS. 1A-1D show various types of conventional frame aggregation and bursting schemes.

FIG. 2 shows a conventional MPDU including an A-MSDU.

FIG. 3 shows an MPDU including an A-MSDU which includes a security field for the entire A-MSDU in accordance with the present invention.

FIG. 4 is a flow diagram of a process for securing an aggregated frame in accordance with the present invention.

FIG. 5 is a block diagram of a wireless transmit/receive unit (WTRU) in accordance with the present invention.

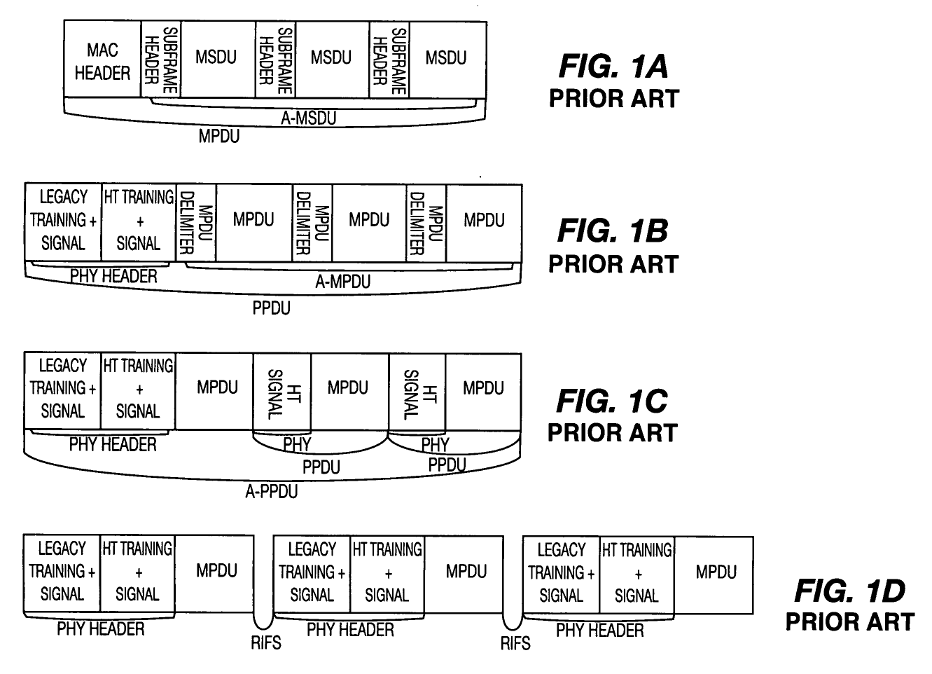

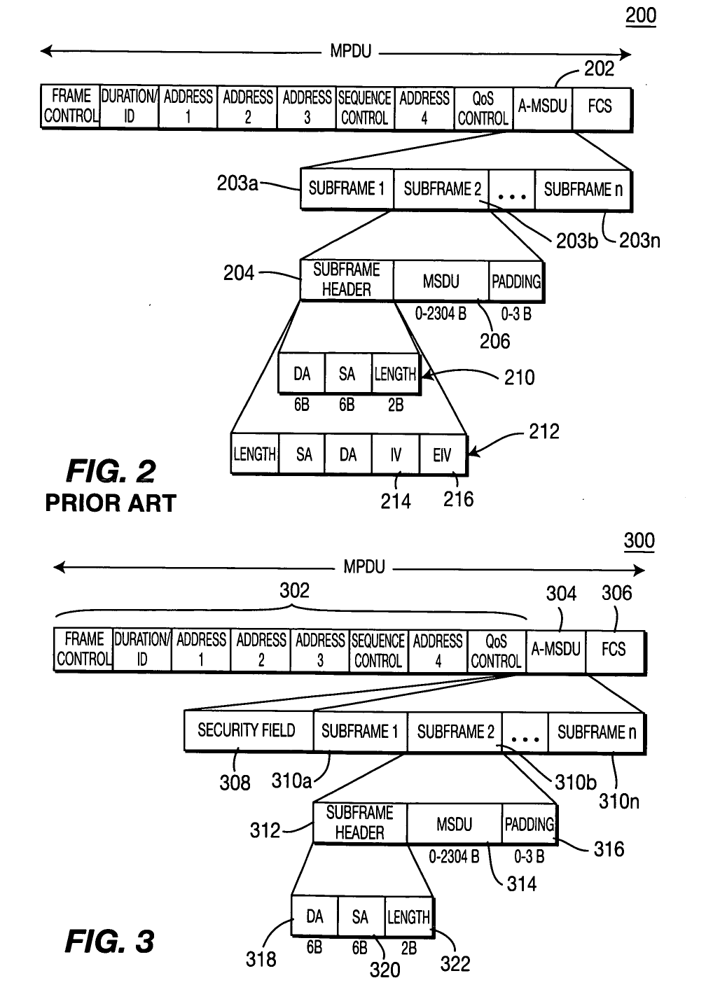

### DETAILED DESCRIPTION OF THE PREFERRED EMBODIMENT

When referred to hereafter, the terminology “WTRU” includes but is not limited to a user equipment (UE), a mobile station, a fixed or mobile subscriber unit, a pager, a base station, a Node-B, a site controller, an access point (AP), or any other type of device capable of operating in a wireless environment.

The features of the present invention may be incorporated into an integrated circuit (IC) or be configured in a circuit comprising a multitude of interconnecting components.

The present invention is applicable to ad-hoc networks, infrastructure networks, mesh networks, basic service set (BSS) WLAN networks, independent BSS (IBSS) WLAN networks, or any wireless communication system including, but not limited to, high speed downlink packet access (HSDPA), high speed uplink packet access (HSUPA), wideband code division multiple access (WCDMA) and code division multiple access 2000 (cdma2000).

In accordance with the present invention, at least one security field is added to an aggregated frame to secure the entire aggregated frame. The aggregated frame may be an A-MSDU, an A-MPDU, an A-PPDU, or any type of frame generated by aggregating one or more frames, or a sequence of frames transmitted in a single burst with preferably a reduced inter-frame spacing (RIFS).

Hereinafter, the present invention will be explained with reference to an MPDU containing an A-MSDU including a security field to secure the entire A-MSDU. However, it should be noted that the present invention is equally applicable to any type of aggregated frames, any type of frame including a plurality of fields destined to one or more receivers, or a sequence of frames transmitted in a signal burst.

FIG. 3 shows an MPDU 300 including an A-MSDU 304 which includes a security field 308 for the entire A-MSDU 304 in accordance with the present invention. The MPDU 300 includes a MAC header 302, a frame body 304, (i.e., A-MSDU), and a frame check sequence (FCS) 306. The A-MSDU 304 contains one or more subframes 310a-310n and the security field 308. Each of the subframes 310a-310n includes a subframe header 312, an MSDU 314 and padding 316. The subframe header 312 includes a destination address (DA) field 318, a source address (SA) field 320, and a length field 322.

The security field 308 includes information to be used to secure and protect encryption and/or integrity of the entire A-MSDU 304 under conventional security protocol, such as IEEE 802.11i. The information may include at least one of an IV, an EIV, an MIC, an ICV, or any information to be used for security purposes based on any security protocols. The security protocols include, but are not limited to, a wired equivalent privacy (WEP), a temporal key integrity protocol (TKIP), a counter-mode/CBC-MAC protocol (CCMP), or any other security protocols that currently exist or will be developed in the future.

In order to generate the contents of the security field 308, a WTRU preferably executes IEEE 802.11i procedures to obtain a group key or a pairwise key, depending on its security needs and/or preferences. If MSDUs 314 within the A-MSDU 304 have different SAs or different DAs, a group key is used to generate the contents of the security field 308. If all the MSDUs 314 within the A-MSDU 304 have the same SA and the same DA, either a group key or a pairwise key may be used. In the latter case, WTRUs, (e.g., a station and an AP), may indicate which key, (i.e., a group key or a pairwise key), is being used for providing security for the aggregated frame. Such an indication may be sent during a prior negotiation, (e.g., setup phase), or may be dynamically adjusted by sending a message, which may be included in a MAC header 302 of the frame.

Alternatively, the WTRU may obtain additional group keys that are designated for specific purposes. For example, the WTRU may obtain a group key, (e.g., via a setup procedure), which is used specifically by WTRUs participating in a certain frame aggregation scheme, (e.g., A-MSDU aggregation). Such a specialized group key can be refreshed or changed from time to time, as a new WTRU associates or disassociates, or at any point in time for the purpose of enhancing security.

Additionally, the MPDU 300 may include a special field, (one bit or a few bits), to indicate whether the MPDU 300 contains the security field 308 for the entire A-MSDU 304, only a conventional security field for individual MSDUs 314, or both. The special field may be included anywhere within the MPDU 300. For example, the special field may be included in a MAC header 302 of the MPDU 300, (e.g., in a control field), or in the security field 308.

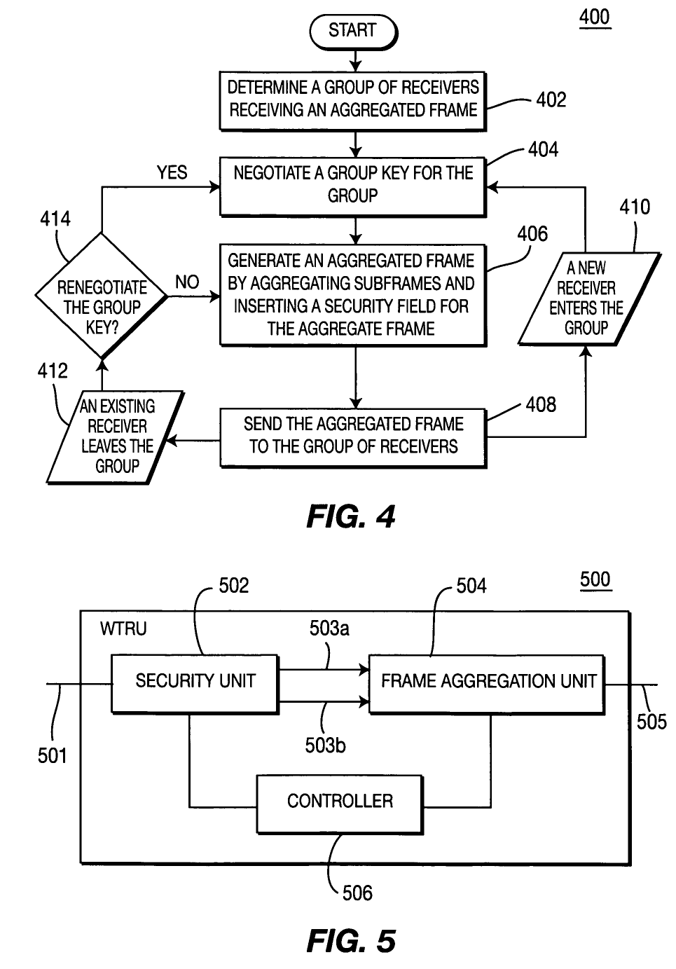

FIG. 4 is a flow diagram of a process 400 for securing an aggregated frame in accordance with the present invention. A WTRU determines a group of receiving WTRUs that will receive an aggregated frame, (when a group key is used to generate the content of the security field) (step 402). The WTRU then negotiates a group key for the group of receiving WTRUs (step 404). Once the group key is negotiated, the WTRU generates an aggregated frame by aggregating at least one subframe and inserting a security field (step 406). The WTRU then sends the aggregated frame to the receiving WTRUs (step 408).

When it is detected that a new WTRU enters into the WLAN at step 410, the process 400 returns to step 404 to renegotiate the group key. When it is detected that any receiving WTRU leaves the WLAN at step 412, the WTRU may determine whether renegotiation of the group key is desirable (step 414). If it is determined that renegotiation is not necessary, the process 400 returns to step 406 to generate another aggregated frame and send it to the receiving WTRUs. If it is decided to renegotiate the group key at step 414, the process 400 proceeds to step 404 to renegotiate the group key.

The scheme of the present invention is applicable to any aggregated frame including a plurality of frames or any one frame including a plurality of fields destined to one or more WTRUs, and may be any type of frame including, but not limited to, data frames, control frames, management frames, action frames, or any type of frames that are currently existing or will be developed in the future. For example, a new frame related to power saving is currently proposed in the context of frame aggregation. Such frames include a Power Saving Aggregation Descriptor (PSAD) frame by WWiSE, a Multiple-receiver Aggregation Multi-Poll (MMP) frame by TGnSync, or Power Save Multi-Poll (PSMP) frame. Even though such frames are not aggregated frames on their own, (i.e., presently an MMP or PSAD consists of one MPDU and also one MSDU), the content of such frames concern multiple receiver addresses that are specified within the body of the MMP or PSAD frame. Furthermore, group keys are used in such MMP or PSAD context where the body of the frame specifies multiple WTRUs as receivers. Such group keys can be the usual ones generated by IEEE 802.11i, or additional, more specific group keys, such as those described in accordance with the present invention specifically for frame aggregation purposes.

FIG. 5 is a block diagram of a WTRU 500 in accordance with the present invention. The WTRU 500 includes a security unit 502, a frame aggregation unit 504 and a controller 506. The security unit 502 receives subframes 501 and performs a security function on the subframes 501. The security function may be an encryption of the subframes, calculation of an ICV, or any other security functions that are currently existing, (such as WEP, TKIP, CCMP), or will be developed in the future. The security unit 502 also generates a content 503b of the security field preferably based on a group key or a pairwise key.

The frame aggregation unit 504 receives output 503a from the security unit 502 and generates an aggregated frame 505 by aggregating at least one subframe and the security field based on the content 503b generated by the security unit 502.

The controller 506 controls the frame aggregation unit 504 and the security unit 502 in a process for transmitting the aggregated frame. The controller 506 obtains the group key or the pairwise key and configures the security unit 502 to generate the contents of the security field based on the group key or the pairwise key. The controller 506 is also configured to detect a new receiver entering into the group or a receiver leaving the group so that a new group key is obtained as a new receiver enters into the group or any receiver leaves the group.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for securing transmission of an aggregated frame in a wireless communication system, the method comprising:
generating an aggregated frame comprising at least one subframe;
generating a security field for the aggregated frame, content of the security field being used to secure the aggregated frame; and
inserting the security field in the aggregated frame, whereby the entire aggregated frame is secured by the security field.

2. The method of claim 1 wherein the aggregated frame is an aggregated medium access control (MAC) service data unit (A-MSDU) including at least one MAC service data unit (MSDU).

3. The method of claim 1 wherein the aggregated frame is an aggregated medium access control (MAC) protocol data unit (A-MPDU) including at least one MAC protocol data unit (MPDU).

4. The method of claim 1 wherein the aggregated frame is an aggregated physical layer (PHY) protocol data unit (A-PPDU) including at least one PHY protocol data unit (PPDU).

5. The method of claim 1 wherein the aggregated frame is a sequence of subframes transmitted consecutively.

6. The method of claim 5 wherein the subframes are transmitted with a reduced interframe spacing (RIFS).

7. The method of claim 1 wherein the content in the security field includes at least one of an initialization vector (IV), an extended IV (EIV), a message integrity code (MIC), and an integrity check value (ICV).

8. The method of claim 1 wherein the content in the security field is generated by at least one of a wired equivalent privacy (WEP), a temporal key integrity protocol (TKIP), and a counter-mode/CBC-MAC protocol (CCMP).

9. The method of claim 1 further comprising:
inserting an individual security field into a subframe header of the at least one subframe, whereby the subframe is secured by the individual security field.

10. The method of claim 9 wherein a special field is included in the aggregated frame to indicate whether the aggregated frame includes the security field, the individual security field, or both.

11. The method of claim 10 wherein the special field is included in a header of the aggregated frame.

12. The method of claim 10 wherein the special field is included in the security field.

13. The method of claim 1 wherein the content of the security field is generated based on either a group key or a pairwise key.

14. The method of claim 13 wherein the group key is used to generate the content of the security field when either destination addresses of the subframes or source addresses of the subframes are different each other.

15. The method of claim 13 wherein either the group key or the pairwise key is selectively used to generate the content of the security field when both destination addresses and source addresses of the subframes are the same.

16. The method of claim 15 further comprising:
sending an indication to indicate whether the group key or the pairwise key is used in generating the content.

17. The method of claim 16 wherein the indication is transmitted during a prior negotiation.

18. The method of claim 16 wherein the indication is transmitted to switch dynamically between the group key and the pairwise key.

19. The method of claim 16 wherein the indication is included in a header of the aggregated frame.

20. The method of claim 13 wherein the group key is obtained only for a group of receivers participating in a frame aggregation scheme.

21. The method of claim 20 further comprising:
detecting a new receiver entering into the group of receivers, whereby a new group key is obtained as the new receiver enters into the group.

22. The method of claim 20 further comprising:
detecting when a receiver leaves the group of receivers; and
obtaining a new group key.

23. The method of claim 20 wherein the group key is changed periodically.

24. The method of claim 1 wherein the subframe is at least one of a data frame, a control frame, a management frame, and an action frame.

25. The method of claim 1 wherein the aggregated frame is a power saving aggregation descriptor (PSAD) frame.

26. The method of claim 1 wherein the aggregated frame is a multiple-receiver aggregation multi-poll (MMP) frame.

27. The method of claim 1 wherein the aggregated frame is a power save multi-poll (PSMP) frame.

28. A wireless transmit/receive unit (WTRU) configured to secure a transmission of an aggregated frame in a wireless communication system, the WTRU comprising:
a security unit configured to perform a security function on subframes in the aggregated frame, and generate a content of a security field which is used to secure the entire aggregated frame; and
a frame aggregation unit coupled to the security unit, the frame aggregation unit being configured to generate an aggregated frame comprising at least one subframe and the security field being based on the content.

29. The WTRU of claim 28 wherein the aggregated frame is an aggregated medium access control (MAC) service data unit (A-MSDU) including at least one MAC service data unit (MSDU).

30. The WTRU of claim 28 wherein the aggregated frame is an aggregated medium access control (MAC) protocol data unit (A-MPDU) including at least one MAC protocol data unit (MPDU).

31. The WTRU of claim 28 wherein the aggregated frame is an aggregated physical layer (PHY) protocol data unit (A-PPDU) including at least one PHY protocol data unit (PPDU).

32. The WTRU of claim 28 wherein the aggregated frame is a sequence of subframes transmitted consecutively.

33. The WTRU of claim 32 wherein the subframes are transmitted with a reduced interframe spacing (RIFS).

34. The WTRU of claim 28 wherein the content in the security field includes at least one of an initialization vector (IV), an extended IV (EIV), a message integrity code (MIC), and an integrity check value (ICV).

35. The WTRU of claim 28 wherein the content in the security field is generated based on at least one of a wired equivalent privacy (WEP), a temporal key integrity protocol (TKIP), and a counter-mode/CBC-MAC protocol (CCMP).

36. The WTRU of claim 28 wherein the frame aggregation unit is configured to insert an individual security field into the subframe for securing the subframe.

37. The WTRU of claim 36 wherein the frame aggregation unit is configured to include a special field in the aggregated frame to indicate whether the aggregated frame contains the security field, the individual security field, or both.

38. The WTRU of claim 37 wherein the special field is included in a header of the aggregated frame.

39. The WTRU of claim 37 wherein the special field is included in the security field.

40. The WTRU of claim 28 wherein the content in the security field is generated based on either a group key or a pairwise key.

41. The WTRU of claim 40 wherein the security unit is configured to use the group key to generate the content in the security field when either destination addresses of the subframes or source addresses of the subframes are different than each other.

42. The WTRU of claim 40 wherein the security unit is configured to selectively use either the group key or the pairwise key to generate the content in the security field when both destination addresses and source addresses of the subframes are the same.

43. The WTRU of claim 42 wherein the frame aggregation unit is configured to send an indication to indicate whether the group key or the pairwise key is used in generating the content.

44. The WTRU of claim 43 wherein the indication is transmitted during a prior negotiation.

45. The WTRU of claim 43 wherein the indication is transmitted to switch dynamically between the group key and the pairwise key.

46. The WTRU of claim 43 wherein the indication is included in a header of the aggregated frame.

47. The WTRU of claim 40 wherein the group key is obtained only for a group of receivers participating in a frame aggregation scheme.

48. The WTRU of claim 47 further comprising:
a controller configured to detect a new receiver entering into the group of receivers, whereby a new group key is obtained as the new receiver enters into the group.

49. The WTRU of claim 47 further comprising:
a controller configured to detect when a receiver leaves the group of receivers and to obtain a new group key.

50. The WTRU of claim 47 wherein the group key is changed periodically.

51. The WTRU of claim 28 wherein the subframe is one of a data frame, a control frame, a management frame and an action frame.

52. The WTRU of claim 28 wherein the aggregated frame is a power saving aggregation descriptor (PSAD) frame.

53. The WTRU of claim 28 wherein the aggregated frame is a multiple-receiver aggregation multi-poll (MMP) frame.

54. The WTRU of claim 28 wherein the aggregated frame is a power save multi-poll (PSMP) frame.

55. A method for securing transmission of an aggregated frame in a wireless communication system, the method comprising:
generating an aggregated frame comprising a plurality of fields, the fields being destined to multiple receivers;
generating a security field for the aggregated frame, wherein content of the security field is used to secure the aggregated frame; and
inserting the security field in the aggregated frame, whereby the entire aggregated frame is secured by the security field.

56. A wireless transmit/receive unit (WTRU) configured to secure a transmission of an aggregated frame in a wireless communication system, the WTRU comprising:
a security unit configured to perform a security function on a plurality of fields included in the aggregated frame and generate a content of a security field which is used to secure the entire aggregated frame, the fields being destined to multiple receivers; and
a frame aggregation unit coupled to the security unit, the frame aggregation unit being configured to generate an aggregated frame comprising the fields and the security field based on the content of the security field.
